(19) United States
(12) Patent Application Publication
(10) Pub. No.: US 2015/0017419 A1
(43) Pub. Date: Jan. 15, 2015

(54) Tagged Porous Masses

(71) Applicant: Celanese Acetate LLC, Irving, TX (US)

(72) Inventors: Raymond M. Robertson, Blacksburg, VA (US); David Nyy, Irving, TX (US)

(73) Assignee: Celanese Acetate LLC, Irving, TX (US)

(21) Appl. No.: 14/322,130

(22) Filed: Jul. 2, 2014

Related U.S. Application Data
(60) Provisional application No. 61/845,624, filed on Jul. 12, 2013.

(51) Int. Cl. A24D 3/06; B29C 70/58; A24D 1/18

(52) U.S. Cl. CPC A24D 3/06; A24D 1/18; B29C 70/58; B29K 2105/16
USPC 428/317.9; 252/408.1; 252/301.16; 252/301.35; 252/62.51 R; 131/360; 264/45.3

(57) ABSTRACT

Porous masses that include taggants may provide for product authentication and counterfeit identification, especially products like smoking device filters and smoking devices. In some instances, a tagged porous mass may include a plurality of binder particles; a taggant that comprises at least one taggant component selected from the group consisting of an elemental marker, a molecular fluorophore, a particulate fluorophore, and any combination thereof; a plurality of second particles, wherein the second particles comprise at least one selected from the group consisting of active particles, organic particles, and any combination thereof; and wherein the binder particles are bound to the second particles at sintered contact points.

### BACKGROUND

The present invention relates to porous masses that comprise taggants to provide for product authentication and counterfeit identification.

Counterfeiting and forgery are among the greatest concerns in the consumer marketplace and the modern global economy. The International Chamber of Commerce estimates that counterfeiting accounts for about 5% to about 7% of world trade, which is about $600 billion annually.

Within the cigarette and related industries, anti-counterfeiting measures have been included in the packaging of the smoking devices or relate filters. For example, holograms and inscriptions have been included on cartons and packs to provide for product authentication. However, the cost for reverse engineering and producing these anti-counterfeiting measures has decreased over the past decade, which makes these anti-counterfeiting measures less effective deterrents. Accordingly, a need exists for anti-counterfeiting measures that are more costly to reverse engineer and reproduce, while keeping the cost to product manufactures low.

### SUMMARY OF THE INVENTION

The present invention relates to porous masses that comprise taggants to provide for product authentication and counterfeit identification.

One embodiment described herein is a tagged porous mass that includes a plurality of binder particles; a taggant that comprises at least one taggant component selected from the group consisting of an elemental marker, a molecular fluorophore, a particulate fluorophore, and any combination thereof; a plurality of second particles, wherein the second particles comprise at least one selected from the group consisting of active particles, organic particles, and any combination thereof; and wherein the binder particles are bound to the second particles at sintered contact points.

Another embodiment described herein is a method that includes introducing a matrix material into a mold cavity, wherein the matrix material comprises a plurality of binder particles, a taggant, and a plurality of second particles; and heating the matrix material so as to yield a tagged porous mass having a plurality of sintered contact points between the binder particles and the taggant and the second particles.

Yet another embodiment described herein is a method that includes introducing a matrix material into a mold cavity, wherein the matrix material comprises a plurality of binder particles and a plurality of second particles; heating the matrix material so as to yield a porous mass having a plurality of sintered contact points between the binder particles and the second particles; and spraying a taggant onto at least a portion of a surface of the porous mass, thereby yielding a tagged porous mass.

The features and advantages of the present invention will be readily apparent to those skilled in the art upon a reading of the description of the preferred embodiments that follows.

### DETAILED DESCRIPTION

The present invention relates to porous masses that comprise taggants to provide for product authentication and counterfeit identification.

As used herein, the term “taggant” refers to an innocuous additive with a unique signature that identifies the product (e.g., the tagged porous masses and products comprising the tagged porous masses described herein). Generally, porous masses may comprise a plurality of binder particles mechanically bound to a plurality of second particles (e.g., active particles, organic particles, or both) at a plurality of sintered contact points, which are described in detail in International Patent Application No. PCT/US2011/044142 (published as WO/2012/054111), U.S. Provisional Application No. 61/781,128, U.S. Provisional Application No. 61/779,232, and U.S. Provisional Application No. 61/781,067.

Porous masses are useful for, inter a/ia, reducing the level of toxins in a smoke stream of a smoking device and/or imparting flavor into a smoke stream of a smoking device. In preferred embodiments, the porous masses may be superior to known technologies, such as Dalmatian filters and flavored filters. As the regulations continue to require that the smoker receive a reduced level of toxins while smoking, porous masses provide a filter technology for meeting or exceeding these regulations and can be incorporated into current smoking device filter and smoking device production methods with minimal adaptation to current assembly technology.

As described herein, the porous masses also provide for an avenue to incorporate anti-counterfeiting measures (i.e., as tagged porous masses) into individual smoking device filters and smoking devices that would impact production of such filters and devices no more than that of the porous mass technology. Further, the anti-counterfeiting measures described herein may be integrated into the porous mass production methods, thereby mitigating additional cost of the tagged porous mass. Therefore, the overall cost increase to the porous mass and its assembly into a smoking article may be minimal relative to incorporation of porous masses without anti-counterfeiting measures.

Further, the tagged porous mass described herein may rely on one or more features for authentication including, but not limited to, (1) composition of the taggant as confirmed by fluorescence, elemental analysis, and the like, (2) the relative concentration of individual taggant components, and (3) location of individual taggants including any specific designs or text from printing. Because of the countless permutations and combinations of these features, the reverse engineering of tagged porous masses becomes more difficult and costly, provides for robust anti-counterfeiting measures.

It should be noted that when “about” is provided herein in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

Tagged porous masses described herein comprise a plurality of binder particles, a taggant, and a plurality of second particles (e.g., active particles, organic particles, or combinations thereof) such that the binder particles are bound to the second particles at sintered contact points. In some embodiments, the taggant may comprise a plurality of taggant particles and the binder particles may be bound to the taggant particles at sintered contact points. It should be noted that as described herein, the particles being bound together does not imply or mean that 100% of each of the particles will be bound together. Rather, for example, some of the binder particles are bound to some of the second particles and some of the taggant particles (where applicable).

Suitable second particles may, in some embodiments, be active particles as described in International Patent Application No. PCT/US2011/044142 (published as WO/2012/054111). One example of an active particle is activated carbon (e.g., activated charcoal or active coal). The activated carbon may be low activity (about 50% to about 75% CCI₄ adsorption), high activity (about 75% to about 95% CCI₄ adsorption), or a combination of both. In another example, active particles that comprise carbon may include nano-scaled carbon particles (e.g., carbon nanotubes of any number of walls, carbon nanohorns, bamboo-like carbon nanostructures, fullerenes and fullerene aggregates, graphene including few layer graphene, and oxidized graphene). Other examples of active particles may include, but are not limited to, ion exchange resins, desiccants, silicates, molecular sieves, silica gels, activated alumina, zeolites, perlite, sepiolite, Fuller's Earth, magnesium silicate, metal oxides (e.g., iron oxide, iron oxide nanoparticles like about 12 nm Fe₃O₄, manganese oxide, copper oxide, and aluminum oxide), gold, platinum, iodine pentoxide, phosphorus pentoxide, nanoparticles (e.g., metal nanoparticles like gold and silver; metal oxide nanoparticles like alumina; magnetic, paramagnetic, and superparamagnetic nanoparticles like gadolinium oxide, various crystal structures of iron oxide like hematite and magnetite, gado-nanotubes, and endofullerenes like Gd@C₆₀; and core-shell and onionated nanoparticles like gold and silver nanoshells, onionated iron oxide, and others nanoparticles or microparticles with an outer shell of any of said materials), any combination thereof, and any combination of the foregoing (including activated carbon). Ion exchange resins include, for example, a polymer with a backbone, such as styrene-divinyl benzene (DVB) copolymer, acrylates, methacrylates, phenol formaldehyde condensates, and epichlorohydrin amine condensates; and a plurality of electrically charged functional groups attached to the polymer backbone. In some embodiments, the active particles are a combination of various active particles. Additional properties of active particles may be found in International Patent Application No. PCT/US2011/044142 (published as WO/2012/054111).

Suitable second particles may, in some embodiments, be organic particles derived from a natural material as described in U.S. Provisional Application No. 61/781,128. In some embodiments, organic particles may be produced by grinding natural compositions. It should be noted that unless otherwise specified, the term “grinding” encompasses similar processes like cutting, chopping, crushing, milling, pulverizing, and the like, including cryogenic versions of the foregoing. Examples of natural compositions of organic particles may include, but are not limited to, cloves, tobacco, coffee beans, cocoa, cinnamon, vanilla, tea, green tea, black tea, bay leaves, citrus peels (e.g., orange, lemon, lime, grapefruit, and the like), cumin, chili peppers, chili powder, red pepper, eucalyptus, peppermint, curry, anise, dill, fennel, allspice, basil, rosemary, pepper, caraway seeds, cilantro, garlic, mustard, nutmeg, thyme, turmeric, oregano, other spices, hops, other grains, sugar, and the like, and any combination thereof. Additional properties of organic particles may be found in U.S. Provisional Application No. 61/781,128.

In some embodiments, the second particles may be a combination of active particles and organic particles described herein.

Examples of binder particles may include, but are not limited to, polyolefins, polyesters, polyamides (or nylons), polyacrylics, polystyrenes, polyvinyls, polytetrafluoroethylene (PTFE), polyether ether ketone (PEEK), non-fibrous plasticized cellulose, derivatives any copolymer thereof, any derivative thereof, and any combination thereof. Examples of suitable polyolefins include, but are not limited to, polyethylene, polypropylene, polybutylene, polymethylpentene, any copolymer thereof, any derivative thereof, any combination thereof and the like. Examples of suitable polyethylenes further include low-density polyethylene, linear low-density polyethylene, high-density polyethylene, ultrahigh molecular weight polyethylene any copolymer thereof, any derivative thereof, any combination thereof and the like. Examples of suitable polyesters include polyethylene terephthalate, polybutylene terephthalate, polycyclohexylene dimethylene terephthalate, polytrimethylene terephthalate, any copolymer thereof, any derivative thereof, any combination thereof and the like. Examples of suitable polyacrylics include, but are not limited to, polymethyl methacrylate, any copolymer thereof, any derivative thereof, any combination thereof and the like. Examples of suitable polystyrenes include, but are not limited to, polystyrene, acrylonitrile-butadiene-styrene, styrene-acrylonitrile, styrene-butadiene, styrene-maleic anhydride, any copolymer thereof, any derivative thereof, any combination thereof and the like. Examples of suitable polyvinyls include, but are not limited to, ethylene vinyl acetate, ethylene vinyl alcohol, polyvinyl chloride, any copolymer thereof, any derivative thereof, any combination thereof and the like. Examples of suitable cellulosics include, but are not limited to, cellulose acetate, cellulose acetate butyrate, plasticized cellulosics, cellulose propionate, ethyl cellulose, any copolymer thereof, any derivative thereof, any combination thereof and the like. In some embodiments, a binder particle may be any copolymer, any derivative, and any combination of the above listed binders. In some embodiments, the binder particulates may be non-fibrous. Additional examples and properties of binder particles may be found in International Patent Application No. PCT/US2011/044142 (published as WO/2012/054111) and U.S. Provisional Application No. 61/781,128.

Additional compositional details of porous masses and organic porous masses (e.g., particle concentrations, particle ratios, additives, porous mass size/shape, optional wrappers, and the like) may be found in International Patent Application No. PCT/US2011/044142 (published as WO/2012/054111) and U.S. Provisional Application No. 61/781,128, respectively.

In some embodiments, taggants may comprise one or more taggant components. Suitable taggant components may include elemental markers, molecular fluorophores, particulate fluorophores, and the like, or a combination thereof. One skilled in the art, with the benefit of this disclosure, should recognize the appropriate considerations when choosing taggant components. For example, when the tagged porous mass is produced for use in conjunction with a smoking devices, the taggant components should be chosen so as to mitigate changes in the flavor of the smoke stream to the consumer, not pose additional health risk, and the like.

As used herein, the term “elemental markers” refers to taggant components that can be identified via elemental analysis (e.g., inductively coupled plasma-atomic emission (“ICP-AE”) spectroscopy, inductively coupled plasma-mass spectroscopy (“ICP-MS”), and the like). Elemental markers may include elements not present in other portions of the tagged porous mass (e.g., titanium, vanadium, chromium, iron, cobalt, nickel, copper, zinc, aluminum, silicon, zirconium, molybdenum, palladium, silver, gold, tin, tungsten, platinum, erbium, gadolinium, and the like). Elemental markers may be in the form of molecules (e.g., gold salts), polymers (e.g., silicone polymers or polymers with copper or other suitable ion chelated thereto), or particulates (e.g., microparticles (about 500 nm to about 250 microns in at least one dimension) or nanoparticles (about 0.5 nm to less than about 500 nm in at least one dimension)).

Generally, fluorophores have an excitation wavelength and emission wavelength. This combination can be used to identify different taggant components that are fluorescent.

Molecular fluorophores may include fluorescent molecules, polymers derivatized with fluorescent molecules, and the like, and any combination thereof. Examples of fluorescent molecules may include acridine dyes, cyanine dyes, fluorine dyes, oxazin dyes, phenanthridine dyes, rhodamine dyes, and the like, and any combination thereof. Examples of polymers suitable for fluorophore derivatization may include, but are not limited to, polyvinypyrrolidone, polyacrylic acid, polyacrylamide, polymethacrylamides, polyamine, polyethyleneimine, and the like. Suitable polymers may also be copolymers comprising monomeric units corresponding at least one of the foregoing polymers. As used herein, the term “copolymer” encompasses polymers with two or more monomeric units, (e.g., alternating copolymers, statistic copolymers, random copolymers, periodic copolymers, block copolymer (e.g., diblock, triblock, and so on), terpolymers, graft copolymers, branched copolymers, star polymers, and the like, or any hybrid thereof).

Examples of particulate fluorophores may include fluorescent nanoparticles (e.g., having a diameter (or at least one dimension) being about 1 nm to about 500 nm) like metal nanoparticles (e.g., gold, silver, platinum, palladium, cobalt, zinc, nickel, tin, and the like, and alloys thereof like gold silver nanoparticles), metal oxide nanoparticles (e.g., silica nanoparticles, titania nanoparticles, iron oxide nanoparticles, zinc oxide nanoparticles, iron zinc oxide nanoparticles, and the like), magnetic nanoparticles (e.g., iron oxide nanoparticles, iron cobalt nanoparticles, and the like), quantum dots (e.g., cadmium selenide nanoparticles, cadmium sulfide nanoparticles, cadmium telluride nanoparticles, indium arsenide nanoparticles, and indium phosphide nanoparticles, and the like), carbon nanoparticles (e.g., single-walled carbon nanotubes, double walled carbon nanotubes, graphene oxide, graphene oxide ribbons, and the like), and any combination thereof.

Another example of particulate fluorophores may include core-shell nanoparticles wherein at least the shell is nano-dimensional. As used herein, the term “core-shell” refers to particles having a core material with at least one shell disposed thereabout (including less than 100% coverage). It should be noted that the term “core-shell” encompasses multiple shells, sometimes referred to as onionated nanoparticles. In some embodiments, a core-shell nanoparticle may comprise a metal oxide or quantum dot core and at least one nano-thick layer (e.g., about 0.5 nm to about 150 nm), wherein the nano-thick layer comprises a metal oxide, a metal, and the like (e.g., a quantum dot described herein, a silica, titania, zinc oxide, or iron oxide core with at least one shell comprising gold, silver, platinum, cobalt, silica, and the like).

By way of nonlimiting example, the taggant may comprise 3 nm gold particles, 10 nm gold particles, and 25 nm gold particles with relative concentrations of 1:5:2 such that the fluorophore particles in combination with the concentration provide for three emission peaks of varying height at a given excitation wavelength. By way of another nonlimiting example, a taggant may comprise a molecular fluorophore and a particulate fluorophore such that at a first excitation wavelength the molecular fluorophore emits a first emission wavelength and the particulate fluorophore has no emission and at a second excitation wavelength the particulate fluorophore emits a second emission wavelength and the molecular fluorophore has no emission.

In some embodiments, the tagged porous masses described herein may comprise taggant in an amount ranging from a lower limit of about 0.0005 wt %, 0.005 wt %, 0.01 wt %, 0.5 wt %, or 1 wt % of the tagged porous mass to an upper limit of about 10 wt %, 5 wt %, or 1 wt % of the tagged porous mass, and wherein the amount of active particles can range from any lower limit to any upper limit and encompass any subset therebetween. It should be noted that concentrations outside these preferred ranges may be useful. For example, taggant components with high emission efficiencies may be at lower concentrations. In another example, an active particles like iron oxide nanoparticles may also be useful as a taggant or a taggant component and accordingly may be at a higher concentration (e.g., about 25 wt% to about 90 wt%). That is, where the chosen active particle may also be used as a taggant, it may be desirable to raise the level of the material in the porous mass such that not only are the toxins reduced to a desired level but the material can also be used to identify true, non-counterfeit goods. In some embodiments, it may be desirable to choose a taggant that is distinct from any active particle that is included in the porous mass. One of skill in the art will recognize that, in cases where the selected taggant may also act as an active particle, the action of the two taken together should be considered in designing an anti-counterfeit, toxin reducing porous mass.

Additional compositional details of porous masses and organic porous masses (e.g., particle concentrations, particle ratios, additives like flavorants and microwave enhancement additives, porous mass size/shape, optional wrappers, inclusion of cavities, inclusion of capsules, and the like) may be found in International Patent Application No. PCT/US2011/044142 (published as WO/2012/054111) and U.S. Provisional Application No. 61/781,128, respectively.

Production of tagged porous masses may be performed by methods disclosed in U.S. Provisional Application No. 61/779,232 and U.S. Provisional Application No. 61/781,067. Generally, production methods may involve introducing a matrix material into a mold cavity, wherein the matrix material comprises the binder particles, the second particles, optionally the taggant (or a taggant component thereof), and optionally additives; and heating the matrix material so as to form a plurality of sintered contact points between the binder particles and the second particles (and, if applicable, between the binder particles and a taggant component that is particulate in nature (e.g., particulate fluorophores)), thereby yielding a porous mass (or a tagged porous mass if taggant is included in the matrix material). In some instances, a wrapper (e.g., paper) may be included as a liner for the mold cavity, as the mold cavity, and the like. The wrapper may, in some instances, be included in the produced porous mass. Additional production method details (e.g., continuous vs batch production, production speed, feeding methods like gravimetric heating or pneumatic dense phase feeding, heating methods like convection heating or microwave heating, and additional steps like cutting, cooling, extruding, sanding, and the like) may be found in U.S. Provisional Application No. 61/779,232 and U.S. Provisional Application No. 61/781,067.

Taggants or taggant components may be incorporated into the production method at a plurality of steps (e.g., included as a component of the matrix material, sprayed on the wrapper, printed in a design or text on the wrapper, printed in a design or text directly on the porous mass after heating, sprayed on the porous mass after heating, included in the adhesive used in conjunction with the wrapper, and the like). In some instances, two or more taggant components may be incorporated into a production method in more than one step.

Taggants may be included in tagged porous masses in a plurality of locations (e.g., dispersed throughout the tagged porous mass, substantially on the outside of the tagged porous mass, disposed on a wrapper of the tagged porous mass, dispersed in the adhesive used in conjunction with the wrapper, and the like, and any combination thereof). In some embodiments, a first taggant component may be included in a first location and a second taggant component may be includes in a second location different from the first location. For example, a molecular fluorophore may be included in an ink used to print a design or text on the wrapper and a particulate fluorophore may be included in the matrix material used to produce the tagged porous masses. In another example, a particulate fluorophore may be included in the matrix material, and a particulate fluorophore may be sprayed on the surface of the tagged porous mass after heating (e.g., the entire surface or a portion thereof like a stripe down along the length of the porous mass).

As described in International Patent Application No. PCT/US2011/044142 (published as WO/2012/054111), U.S. Provisional Application No. 61/781,128, U.S. Provisional Application No. 61/779,232, and U.S. Provisional Application No. 61/781,067, the tagged porous masses described herein may be included as a portion of a smoking device filter. In some embodiments, a smoking device may comprise at least one tagged porous mass and at least one filter section. The smoking device filter may, in some embodiments, have a configuration that includes, in order, a first filter section (e.g., having a cellulose acetate or other traditional filter composition), a tagged porous mass, and a second filter section (e.g., having a cellulose acetate or other traditional filter composition). Additional smoking device filter composition and production method details (e.g., filter section compositions, filter section lengths, filter section sizes, smoking device filter production speed, additional smoking device filter configurations, packs of smoking device filters, and cartons of smoking device filters, and the like) may be found in the above referenced applications.

As described in International Patent Application No. PCT/US2011/044142 (published as WO/2012/054111), U.S. Provisional Application No. 61/781,128, U.S. Provisional Application No. 61/779,232, and U.S. Provisional Application No. 61/781,067, the tagged porous masses described herein may be included as a portion of a smoking device. In some embodiments, a smoking device may comprise a tagged porous mass in fluid communication with a smokeable substance. In some embodiments, the smoking device may further comprise a housing capable of maintaining the tagged porous mass in fluid communication with the smokeable substance. Additional smoking device composition and production method details (e.g., smokeable substance compositions, smoking device sizes, smoking device production speed, smoking device configurations, packs of smoking devices, and cartons of smoking devices, and the like) may be found in the above referenced applications.

Some embodiments for authenticating tagged porous masses described herein may involve irradiating at least a portion of the tagged porous mass with at least one excitation spectrum ranging from ultraviolet to infrared, so as to yield an emission spectrum corresponding to the tagged porous mass; and observing and comparing the emission spectrum to a reference emission spectrum corresponding to a reference tagged porous mass. It should be noted that the term “spectrum” relative to excitation or emission encompasses single wavelengths, multiple independent wavelengths, a continuum of wavelengths, multiple independent continuums of wavelengths, and any combination thereof. For example, multiple independent wavelengths may be 1064 nm, 632 nm, and 515 nm. In another example, a continuum of wavelengths in combination with an independent wavelength may include 450 nm to 725 nm and 1064 nm.

In some instances, the portion of the tagged porous mass used for authentication may be the surface of the tagged porous mass, the wrapper disposed thereabout, and/or the adhesive used in conjunction with the wrapper. In some instances, the portion of the tagged porous mass used for authentication may be the cross-section of the porous mass. In some instances, the portion of the tagged porous mass used for authentication may be a portion that is ground and optionally washed with a solvent before irradiating.

In some instances, observing may be by eye. In some instances, observing may utilize a spectrometer. In some instances, observing may utilize a spectrometer capable of corresponding emission spectrum with location (e.g., a camera, a microscope, and the like).

In some instances, comparing may involve determining if certain wavelengths of an emission spectrum are present or absent. In some instances, comparing may involve analyzing the intensity and relative intensity (when two or more are present) of certain wavelengths of an emission spectrum. In some instances, comparing may involve comparing the emission spectrum and location thereof of the tagged porous mass to the reference tagged porous mass (e.g., when a design is utilized as part of the anti-counterfeiting measures).

Some embodiments for authenticating tagged porous masses described herein may involve taking a sample from at least a portion of the tagged porous mass; analyzing the sample for elemental composition; and comparing the elemental composition to a reference elemental composition corresponding to a reference tagged porous mass. Some embodiments for authenticating tagged porous masses described herein may involve taking at least two samples from different portions of the tagged porous mass; analyzing the samples for elemental composition; and comparing the elemental composition and location of the samples to a reference tagged porous mass (e.g., when a design is utilized as part of the anti-counterfeiting measures).

Embodiments disclosed herein include:

A. a tagged porous mass that includes a plurality of binder particles; a taggant that comprises at least one taggant component selected from the group consisting of an elemental marker, a molecular fluorophore, a particulate fluorophore, and any combination thereof; a plurality of second particles, wherein the second particles comprise at least one selected from the group consisting of active particles, organic particles, and any combination thereof; and wherein the binder particles are bound to the second particles at sintered contact points;

B. a method that includes introducing a matrix material into a mold cavity, wherein the matrix material comprises a plurality of binder particles, a taggant, and a plurality of second particles; and heating the matrix material so as to yield a tagged porous mass having a plurality of sintered contact points between the binder particles and the taggant and the second particles; and

C. a method that includes introducing a matrix material into a mold cavity, wherein the matrix material comprises a plurality of binder particles and a plurality of second particles; heating the matrix material so as to yield a porous mass having a plurality of sintered contact points between the binder particles and the second particles; and applying (e.g., spraying, printing, and the like) a taggant onto at least a portion of a surface of the porous mass (or a wrapper disposed thereon), thereby yielding a tagged porous mass.

Each of embodiments A, B, and C may have one or more of the following additional elements in any combination: Element 1: the taggant or taggant component being disposed on the surface of the tagged porous mass; Element 2: the taggant or taggant component being dispersed throughout the tagged porous mass; Element 3: the taggant or taggant component being at least one of an elemental marker, a molecular fluorophore, a particulate fluorophore, or a combination thereof; Element 4: the taggant being present in an amount of about 0.0005 wt %, to about 10 wt % of the tagged porous mass; Element 5: the tagged porous mass further including a wrapper (e.g., a paper) disposed about the tagged porous mass; Element 6: the tagged porous mass further including a wrapper disposed about the tagged porous mass, wherein at least one taggant component of the taggant is disposed on the wrapper; Element 7: the tagged porous mass of Element 5 wherein an adhesive comprising at least one taggant component is used in conjunction with the wrapper.

By way of non-limiting example, exemplary combinations applicable to A, B, C include: Element 3 in combination with Element 4; Element 1 in combination with any of the foregoing; Element 2 in combination with any of the foregoing; Element 5 (optionally in combination with Element 7) in combination with any of the foregoing; Element 6 in combination with any of the foregoing; and so on.

Additional embodiments described herein may include smoking device filters, smoking devices, or the like that include a tagged porous mass of Embodiment A or produced by Embodiment B or C, each independently optionally including one or more of Elements 1-7.

While compositions and methods are described in terms of “comprising” various components or steps, the compositions and methods can also “consist essentially of” or “consist of” the various components and steps. When “comprising” is used in a claim, it is open-ended.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention disclosed herein are presented below. Not all features of an actual implementation are described or shown in this application for the sake of clarity. It is understood that in the development of an actual embodiment incorporating the present invention, numerous implementation-specific decisions must be made to achieve the developer's goals, such as compliance with system-related, business-related, government-related and other constraints, which vary by implementation and from time to time. While a developer's efforts might be complex and time-consuming, such efforts would be, nevertheless, a routine undertaking for those of ordinary skill the art having benefit of this disclosure.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A tagged porous mass comprising:
a plurality of binder particles;
a taggant that comprises at least one taggant component selected from the group consisting of an elemental marker, a molecular fluorophore, a particulate fluorophore, and any combination thereof;
a plurality of second particles, wherein the second particles comprise at least one selected from the group consisting of active particles, organic particles, and any combination thereof; and
wherein the binder particles are bound to the second particles at sintered contact points.

2. The tagged porous mass of claim 1, wherein the taggant component is disposed on the surface of the tagged porous mass.

3. The tagged porous mass of claim 1, further comprising a wrapper disposed about the tagged porous mass.

4. The tagged porous mass of claim 3, wherein the taggant component is disposed on the wrapper.

5. The tagged porous mass of claim 1, wherein the elemental marker comprises at least one selected from the group consisting of titanium, vanadium, chromium, iron, cobalt, nickel, copper, zinc, aluminum, silicon, zirconium, molybdenum, palladium, silver, gold, tin, tungsten, platinum, erbium, gadolinium, and any combination thereof.

6. The tagged porous mass of claim 1, wherein the molecular fluorophore includes a fluorescent molecule that comprises at least one selected from the group consisting of an acridine dye, a cyanine dye, a fluorine dye, an oxazin dye, a phenanthridine dye, a rhodamine dye, and any combination thereof.

7. The tagged porous mass of claim 1, wherein the molecular fluorophore includes a polymers having a fluorophore derivatization, wherein the polymer comprises at least one selected from the group consisting of polyvinypyrrolidone, polyacrylic acid, polyacrylamide, a polymethacrylamide, polyamine, polyethyleneimine, a copolymer thereof, and any combination thereof.

8. The tagged porous mass of claim 1, wherein the particulate fluorophore a a metal nanoparticle, a metal oxide nanoparticles, a magnetic nanoparticle, a quantum dots, a carbon nanoparticle, and any combination thereof.

9. A smoking device filter comprising the tagged porous mass of claim 1.

10. A smoking device comprising the tagged porous mass of claim 1.

11. A method comprising:
introducing a matrix material into a mold cavity, wherein the matrix material comprises a plurality of binder particles, a taggant, and a plurality of second particles, wherein the taggant comprises at least one taggant component selected from the group consisting of an elemental marker, a molecular fluorophore, a particulate fluorophore, and any combination thereof; and
heating the matrix material so as to yield a tagged porous mass having a plurality of sintered contact points between the binder particles and the taggant and the second particles.

12. The method of claim 11, wherein the elemental marker comprises at least one selected from the group consisting of titanium, vanadium, chromium, iron, cobalt, nickel, copper, zinc, aluminum, silicon, zirconium, molybdenum, palladium, silver, gold, tin, tungsten, platinum, erbium, gadolinium, and any combination thereof.

13. The method of claim 11, wherein the molecular fluorophore includes a fluorescent molecule that comprises at least one selected from the group consisting of an acridine dye, a cyanine dye, a fluorine dye, an oxazin dye, a phenanthridine dye, a rhodamine dye, and any combination thereof.

14. The method of claim 11, wherein the molecular fluorophore includes a polymers having a fluorophore derivatization, wherein the polymer comprises at least one selected from the group consisting of polyvinypyrrolidone, polyacrylic acid, polyacrylamide, a polymethacrylamide, polyamine, polyethyleneimine, a copolymer thereof, and any combination thereof.

15. The method of claim 11, wherein the particulate fluorophore a a metal nanoparticle, a metal oxide nanoparticles, a magnetic nanoparticle, a quantum dots, a carbon nanoparticle, and any combination thereof.

16. A method comprising:
introducing a matrix material into a mold cavity, wherein the matrix material comprises a plurality of binder particles and a plurality of second particles;
heating the matrix material so as to yield a porous mass having a plurality of sintered contact points between the binder particles and the second particles;
applying a taggant onto at least a portion of a surface of the porous mass, thereby yielding a tagged porous mass, wherein the taggant comprises at least one taggant component selected from the group consisting of an elemental marker, a molecular fluorophore, a particulate fluorophore, and any combination thereof.

17. The method of claim 16, wherein the elemental marker comprises at least one selected from the group consisting of titanium, vanadium, chromium, iron, cobalt, nickel, copper, zinc, aluminum, silicon, zirconium, molybdenum, palladium, silver, gold, tin, tungsten, platinum, erbium, gadolinium, and any combination thereof.

18. The method of claim 16, wherein the molecular fluorophore includes a fluorescent molecule that comprises at least one selected from the group consisting of an acridine dye, a cyanine dye, a fluorine dye, an oxazin dye, a phenanthridine dye, a rhodamine dye, and any combination thereof.

19. The method of claim 16, wherein the molecular fluorophore includes a polymers having a fluorophore derivatization, wherein the polymer comprises at least one selected from the group consisting of polyvinypyrrolidone, polyacrylic acid, polyacrylamide, a polymethacrylamide, polyamine, polyethyleneimine, a copolymer thereof, and any combination thereof.

20. The method of claim 16, wherein the particulate fluorophore a a metal nanoparticle, a metal oxide nanoparticles, a magnetic nanoparticle, a quantum dots, a carbon nanoparticle, and any combination thereof.
